(19) United States
(12) Patent Application Publication
(10) Pub. No.: US 2008/0115068 A1
(43) Pub. Date: May 15, 2008

(54) SYSTEM AND METHOD TO ENHANCE INSTANT MESSAGING

(75) Inventor: Lawrence C. Smith, Cary, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/536,090

(22) Filed: Nov. 13, 2006

(51) Int. Cl. G06F 3/00

(52) U.S. Cl. 715/758

(57) ABSTRACT

A method to dynamically generate a topic audience for a primary user to participate therein is disclosed. The topic audience is defined by users interested in a same discussion topic of a plurality of discussion topics within an electronic discussion group, the topic audience having a size value defined by a number of users interested in the same topic. The method includes specifying a target topic of discussion including a first topic audience defined by users interested in the target topic, searching the plurality of discussion topics, identifying a set of topics related to the target topic, making available to the primary user for selection the set of topics related to the target topic, and expanding the first topic audience to be defined by a second user interested in the selected topic.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to electronic conversation, and particularly to instant messaging and chat applications.

2. Description of Background

In current instant messaging, or chat, applications, a range of topics is provided for online discussion. Users navigate to and select the particular topic in which they are interested, but often there are few participants. Meanwhile, other users may be active in semantically related topics, but they are not aware of the participants in the related topics.

Known solutions are for users to manually monitor multiple chat rooms. This results in a complex chat environment for the users, as multiple windows or very busy chat screens can occur. Accordingly, there is a need for an electronic chat arrangement that overcomes these drawbacks.

### SUMMARY OF THE INVENTION

The shortcomings of the prior art are overcome and additional advantages are provided through the provision of an electronic chat method and system to dynamically create expanded topic audiences within a single chat context window.

An embodiment of the invention includes a method to dynamically generate a topic audience for a primary user to participate therein, the topic audience being defined by users interested in a same discussion topic of a plurality of discussion topics within an electronic discussion group, the topic audience having a size value defined by a number of users interested in the same topic. The method includes specifying, by the primary user, a target topic of discussion, the target topic of discussion being of interest to the primary user and comprising a first topic audience defined by users interested in the target topic and a minimum size value of the first topic audience.

In response to a size value of the first topic audience being less than the specified minimum size value, the method continues by searching the plurality of discussion topics and identifying a set of topics related to the target topic, and making available to the primary user for selection the set of topics related to the target topic. Following selection by the primary user of a topic of the set of topics related to the target topic, expanding the first topic audience to be defined by a second user interested in the selected topic.

Further, if the second user is also participating in a second topic audience defined by a set of users interested in an additional topic, the method includes making available to the primary user for selection the additional topic. Following selection by the primary user of the additional topic, expanding the first topic audience to be defined by the set of users interested in the selected additional topic, and building a chat context using the expanded first topic audience defined by at least one of the second user and the set of users.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which will dynamically create an expanded chat topic audience within a single chat context window, thereby providing the user with a simpler method to increase participation within electronic conversations of interest.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a pictorial representation of an electronic chat system in accordance with an embodiment of the invention.

FIG. 2 illustrates one example of an embodiment of a directed graph topic organization structure in accordance with an embodiment of the invention.

FIG. 3 illustrates one example of an embodiment of a hierarchy topic organization structure in accordance with an embodiment of the invention.

FIG. 4 illustrates one example of a pictorial representation of chat contexts, in accordance with an embodiment of the invention.

FIG. 5 illustrates one example of the chat context in accordance with an embodiment of the invention.

FIG. 6 illustrates one example of a flowchart of a method to expand a topic audience of an electronic conversation in accordance with an embodiment of the invention.

The detailed description explains the preferred embodiments of the invention, together with advantages and features, by way of example with reference to the drawings.

### DETAILED DESCRIPTION OF THE INVENTION

In an embodiment of the invention, a user is given visibility to other users participating in semantically nearby, or related topics providing a wider audience of chat participation and an opportunity to include users in online discussions of which they would not otherwise be aware. For example, when instant message chat topics are organized hierarchically, topic A.B.A is the child of topic A.B, which is the child of topic A. Furthermore, the topic A.B.B is the child of topic A.B, which is the child of topic A. In a typical chat application, users monitoring topic A.B.A would not be aware of other users monitoring topic A.B.B. In an embodiment of the invention, users are given visibility of other users participating in other topics, thereby allowing for the dynamic construction of a topic audience including a combination of both A.B.A and A.B.B, based on their relationship through topic A.B. This new topic audience context lets both A.B.A users and A.B.B users know that each other exist so that they can choose to participate in common aspects of their discussions related by topic.

An embodiment of the invention provides a system and process for a user to specify a target topic audience size when participating in a particular chat topic. In response to the number of participants in the selected target topic being fewer than the specified target topic audience size, the method will scan the system to find related topics and build a single chat context that includes participants in nearby related topics. The result is a dynamically constructed topic audience built as a converged group. In an embodiment, chat messages sent within the context of one topic are broadcast to others in the topic audience.

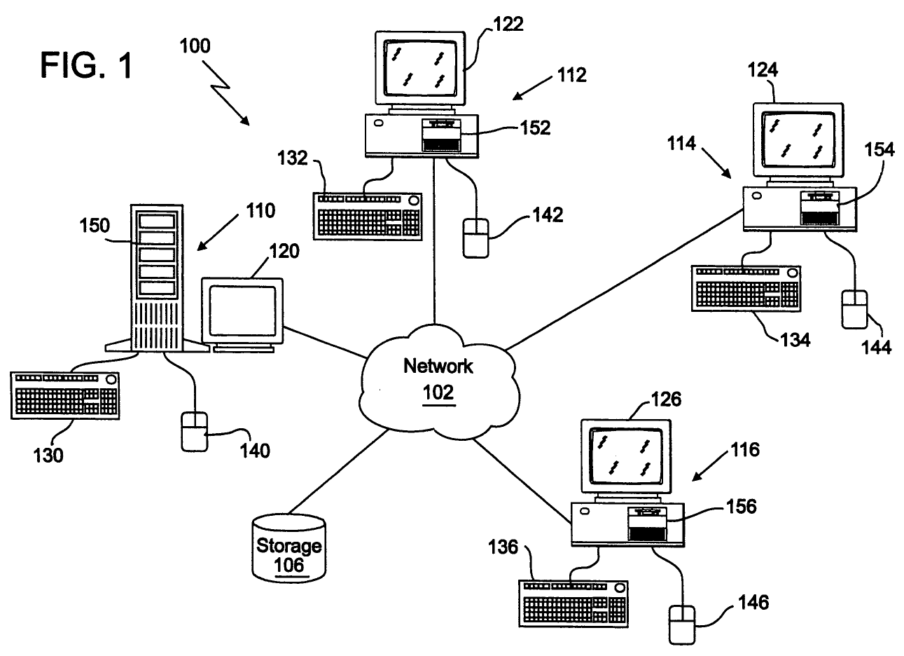

With reference now to the figures, and in particular, with reference to FIG. 1, a pictorial representation of an electronic chat system 100 in which the present invention may be implemented is depicted. The electronic chat system 100 is configured to dynamically generate a topic audience for a primary user to participate therein. The topic audience is defined by users interested in a same discussion topic of a plurality of discussion topics within an electronic discussion group.

Electronic chat system 100 includes a network 102, which is the medium used to provide communication links between various devices and computers connected together within the electronic chat system 100. The network 102 may include permanent connections, such as wire or fiber optic cables, temporary connections made through telephone connections, or wireless connections, for example.

In the depicted example, computers 110-116 are each connected to the network and are configured to provide electronic communication via the network 102. Computer 110 is a chat server configured to host a plurality of chat topic audiences, each topic audience including at least one user interested in the same discussion topic. A size value of the topic audience is defined by a number of users interested in the same discussion topic. Computers 112-116 are chat clients configured to be responsive to a target topic of discussion specified by the primary user, the target topic of discussion being of interest to the primary user. A first topic audience of the target topic is defined by users interested in the target topic. The chat clients 112-116 may be, for example, personal computers or network computers. The electronic chat system 100 may include additional computers, such as servers, and clients, for example, and other devices not shown. A storage device 106 may be used to store and retrieve data associated with the discussion topics.

In an example, the electronic chat system 100 includes the Internet, with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems, that route data and messages. Of course, the electronic chat system 100 may also be implemented as a number of different types of networks 102, such as an Intranet or a local area network, for example.

Each chat server 110 and chat client 112-116 within the electronic chat system 100 may have a program storage device 150-156 to store system, data, and application files. Output devices, such as CRT display screens 120-126, are configured to display a chat window, for example, and input devices, such as keyboards 130-136, and mice 140-146, for example, are configured to enter text to prepare and provide electronic conversations comprising electronic messages, for example. In an embodiment, each chat client 112-116 is configured to communicate with the others via the network 102, in a manner known in the art as instant messaging.

While an embodiment of the invention has been described using keyboards 130-136 and mice 140-146 as input devices, and CRT display screens 120-126 as output devices to conduct electronic communication, it will be appreciated that the scope of the invention is not so limited, and that the invention also applies to electronic chat systems 100 that may utilize alternate input and output devices, such as writing tablets, voice recognition, and audio speakers, for example.

While an embodiment of the invention has been depicted with four computers linked together via a common network for the purposes of electronic communication, it will be appreciated that the scope of the invention is not so limited, and that the invention will also apply to other arrangements of computers or other electronic devices connected together, such as many more computers linked together, via one network in signal communication with another network of computers that may located as far apart as to be on different continents, for example.

FIG. 1 is intended as an example, and not as an architectural limitation for the processes of the present invention.

In an embodiment, the user will specify a target topic of discussion that the user is interested to discuss. The user may also specify a minimum size value of the topic audience in which he would like to participate. For example, the user can specify that they would like to chat with no less than a specified number of other users regarding the target topic and related topics.

If the number of other users within the target topic audience is fewer than the user-specified minimum, the user may be interested to join other chat groups, in order to increase the size value, or number of other users, within the chat context of which the user is a participant. In an embodiment, at least one of the chat client 112-116 and the chat server 110 is configured to be responsive to the size value of the first topic audience of the target topic being less than a primary user-specified minimum size value of the first topic audience.

In an embodiment, chat topics will be arranged in a searchable topic organization structure such that related topics can be identified. It is contemplated to achieve this organization via at least one of a relational database, keyword searching across a domain, or topic indexing services. In an embodiment, at least one of the chat client 112-116 and the chat server 110 is configured to arrange the plurality of discussion topics into the topic organization structure for identifying the set of topics related to the target topic.

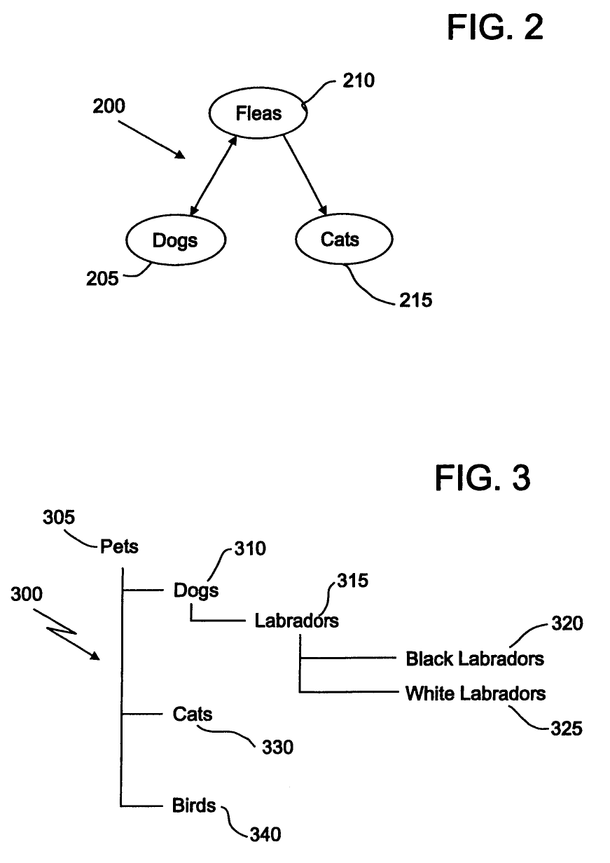

Referring now to FIG. 2, an embodiment of a directed graph 200 is depicted. The directed graph 200 is an embodiment of the topic organization structure. The directed graph 200 is a representation of a set of relationships wherein each object is represented as a circle and each relationship is represented as an arrow. The arrow indicates that one object is related to another object. As depicted in FIG. 2, the directed graph 200 is used to describe the relationship between topics. For example, “dogs” 205 may be related to “fleas” 210 which may be related to “cats” 215 and “dogs” 205. Accordingly, in an embodiment, analysis of the directed graph 200 by the electronic chat system 100 can identify that “dogs” 205 are related to “cats” 215.

Referring now to FIG. 3, an embodiment of a hierarchy 300 is depicted. The hierarchy 300 is another embodiment of the topic organization structure, including a representation of the set of relationships such that there are parent objects 305, 310, 315 and children objects 310-340. The lowest objects 320, 325, 330, 340, from which no children objects 310-340 depend, are often known as leafs. In an embodiment, a hierarchy can be used to show a level of detail for the topic. For example, the topic of “pets” 305 may be represented such that it includes child nodes representing “dogs” 310, “cats” 330 and “birds” 340. Accordingly, in an embodiment, analysis of the hierarchy 300 by the electronic chat system 100 can identify that “Black Labradors” 320 are related to “White Labradors” 325, and that “dogs” 310 may be related to “cats” 330.

Another embodiment of the topic organization structure is a set definition. The set definition is an arbitrary, user-defined, collection of objects including at least two objects in the set. In an embodiment, if the user defines the set of topics to include both “dogs” and “cats”, then “dogs” will be identified by the electronic chat system 100 to be related to “cats”.

Another embodiment of the topic organization structure is a keyword-based categorization. The keyword-based categorization will organize and categorize objects based upon keywords that may be used to describe them. Accordingly, in an embodiment, if the topics of “cats” and “dogs” each contain the keyword “pets”, they will be identified by the electronic chat system 100 to be related.

In an embodiment, at least one of the chat client 112-116 and the chat server 110 is configured to arrange the plurality of discussion topics into the topic organization structure including one of the directed graph, the hierarchy, the set definition, and the keyword-based categorization structure.

In an embodiment, in response to the size value of the first topic audience of the target topic being less than the primary user-specified minimum size value of the first topic audience, at least one of the chat client 112-116 and the chat server 110 is configured to search the plurality of discussion topics hosted by the chat server 110, and identify a set of topics related to the target topic. In an embodiment, at least one of the chat client 112-116 and the chat server 110 is configured to make available for selection by the primary user the set of topics related to the target topic. This will allow the user to examine, and select from, the list of topics that has been identified by the electronic chat system 100 as being related to the target topic initially specified by the user. This will provide for a dynamic topic audience that can be constructed from multiple, populated, and related topics.

The user will then be able to select from the set of topics in which he may decide to participate, and thereby increase the size value, or number of users participating, in the first topic audience, which had initially included only users interested in the target topic. In an embodiment, at least one of the chat client 112-116 and the chat server 110 is configured to be responsive to the primary user selection of a topic of the set of topics related to the target topic, and to expand the first topic audience to be further defined by the inclusion of a second user interested in the selected topic related to the target topic selected by the user. In an embodiment, at least one of the chat client 112-116 and the chat server 110 is configured to display to the primary user a number indicative of a quantity of the second users interested in the topic related to the target topic, thereby allowing the user to select the at least one topic related to the target topic with consideration for the change in the topic audience size that it will cause.

It will be appreciated that some of the second users that are interested in at least one topic of the set of topics related to the target topic may also be interested in yet other, additional topics. This makes available a social network associated with the first topic audience that includes the additional topics that are currently, or recently, discussed by the second user that is currently, or was recently, within the first topic audience. In an embodiment, at least one of the chat client 112-116 and the chat server 110 is configured to be responsive to the second user in the expanded first topic audience also participating in a second topic audience defined by a set of users interested in the additional topic, and to make available to the primary user for selection the additional topic. In an embodiment, at least one of the chat client 112-116 and the chat server 110 is configured to be responsive to primary user selection of the additional topic, and to expand the first topic audience to be defined by the set of users interested in the selected additional topic. In an embodiment at least one of the chat client 112-116 and the chat server 110 is configured to display to the primary user a number indicative of a quantity of the set of users interested in the additional topic, thereby allowing the user to select the additional topic with consideration for the change in the topic audience size that it will cause.

In an embodiment, at least one of the chat client 112-116 and the chat server 110 is configured to build a chat context, or interface, to allow the user to chat with other users, using the dynamically constructed expanded first topic audience defined by at least one of the second user interested in the related topic, and the set of users interested in the additional topic. Messages sent within the chat context are included in chat messages sent to the user. In an embodiment, appropriate on-screen tags and user controls allow appropriate awareness of the other users included within the expanded first topic audience. In an embodiment, appropriate controls will allow the user to filter chat input and respond appropriately in the dynamically constructed chat context. In an embodiment, the chat context includes a single discussion window.

In an embodiment at least one of the chat client 112-116 and the chat server 110 is configured to be responsive to specification by the primary user of a maximum size value of the first topic audience. At least one of the chat client 112-116 and the chat server 110 is configured to be responsive to the size value of the first topic audience being greater than the maximum size value, and to make available to the primary user for selection a list comprising the set of topics, and the additional topic as used to define the expanded first topic audience. In an embodiment, at least one of the chat client 112-116 and the chat server 110 is configured to be responsive to selection by the primary user of at least one of the set of topics, and the additional topic, and to reduce the first topic audience to be defined exclusive of at least one of the second user interested in the selected set of topics and the set of users interested in the selected additional topic, thereby allowing for the reduction of the size value of the first topic audience below the maximum size value specified by the user.

The user may be interested to select the at least one topic related to the target topic from the plurality of discussion topics that have had most recent discussion. In an embodiment, at least one of the chat client 112-116 and the chat server 110 is configured to be responsive to specification by the primary user of a period of time subsequent to a last access by the second user, of the set of topics related to the target topic. In an embodiment, at least one of the chat client 112-116 and the chat server 110 is configured to search the plurality of discussion topics and identify the set of topics related to the target topic that have been accessed within a period of time less than the specified period of time. In an embodiment, the electronic discussion is conducted using an audio format. In an embodiment, the electronic discussion is conducted using a video format.

While an embodiment of the invention has been described using the maximum topic audience size and time period since access as criteria to develop the dynamic topic audience, it will be appreciated that the scope of the invention is not so limited, and that the invention will also apply to electronic chat systems using other criteria to develop the dynamic topic audience, such as the identity of specific audience participants, the use of specific language within the chat context, and the frequency of discussion of specific audience participants, for example.

An embodiment of the invention includes the capability of the user to create additional keyword based categorizations (also known as “tags”) for discussions. The keyword based categorizations may be used to further expand or reduce the topic audience as managed by the electronic chat system 100. In an embodiment the influence of the keywords on topic audience selection is considered in proportion to various factors including the number of users assigning that keyword to the topic, the number of messages related to the topic, and the frequency of interactions within the context of the keyword.

An illustrative example follows: User Sam wants to chat online, and starts a chat context. Because he is interested in dogs, he specifies “Dogs” within his chat context as the target topic of discussion. Because he is not very concerned with having a large discussion group, he specifies a minimum size value of the first topic audience of only two. However, no other users are online discussing dogs. Accordingly, at least one of the chat client 112-116 and the chat server 110 searches the available topics and identifies cats as a topic related to dogs, with one user, user Lou, in the cats group. Sam selects the related topic, “Cats” to expand the first topic audience, of which he is a participant, to now include the user Lou, who interested in cats. User Sam and user Lou discuss cats.

User Lou has also indicated an interest in birds, therefore, user Lou's chat context includes both cats and birds. Because user Sam is chatting with user Lou (or, stated alternatively, is a participant of the first topic audience that now includes user Lou), and user Lou is also chatting about birds, the additional topic of “Birds” of the second topic audience of which user Lou is a participant, will be made available to user Sam for selection. User Sam decides not to select the “Birds” topic.

In a similar manner, because user Sam has expanded the first topic audience of which he is member to include the other users that have selected the “Cats” topic, user Lou will be offered the additional topic of “Dogs”, because that is the target topic that user Sam has indicated. Lou decides to not to select the “Dogs” topic, and thereby, to decline to expand the second topic audience of which he is a member beyond those users that have selected the “Cats” and “Birds” topics.

User Tom joins the “Birds” discussion with user Lou. Following some discussion about birds, user Tom adds “Bird Flu” to his chat context. The topic audience for the “Bird Flu” topic includes many users discussing bird flu. The “Bird Flu” topic is now made available to both user Sam and user Lou for selection to expand their respective topic audiences. User Sam and user Lou both select the “Bird Flu” topic, and accordingly, each of their topic audiences are expanded to include the users that are chatting about the bird flu topic.

This example depicts how semantically linked topics, “Dogs” and “Cats” are used to allow users to select the at least one topic related to the target topic, and thereby expand their topic audience as desired. The example also depicts how socially linked items, in this case the topics “Birds” and “Bird Flu”, are used to allow users to select the at least one additional topic that is made available based upon the interest of at least one other user in the first topic audience also participating in the second topic audience.

An analogy is sitting at a large round table in a banquet, wherein each person is participating in one or two conversations. The conversations may take on a dynamic nature, as spillover from conversations that are topically or socially interconnected is noticed, causing the conversations to gain or lose members of their respective topic audiences. As such, the “walls” that make up the “chatrooms” may be considered to be removed, as the structure of the discussions within the electronic discussion group becomes dynamic and fluid, rather than static and rigid.

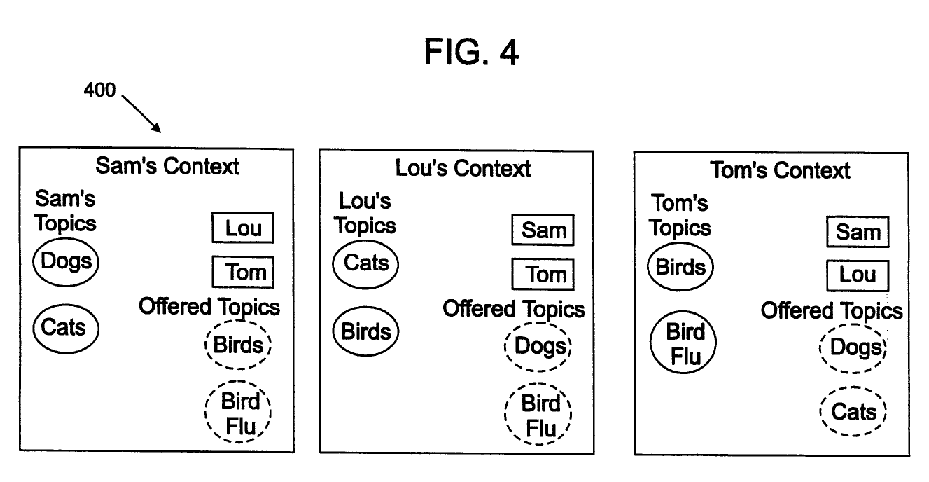

Referring now to FIG. 4, a pictorial representation 400 of the chat contexts, showing the relationships between the topics and the users, from a perspective of each exemplary user described above is depicted. It will be appreciated that the relationships are dynamic, and that the representation of FIG. 4 depicts the status following user Sam's selection of the at least one related topic of “Cats”, but prior the selection by user Sam and user Lou of the at least one additional topic of “Bird Flu”. It will be further appreciated that additional users, included within topic audience of “Bird Flu” are removed from the representation of user Tom's chat context for clarity of illustration.

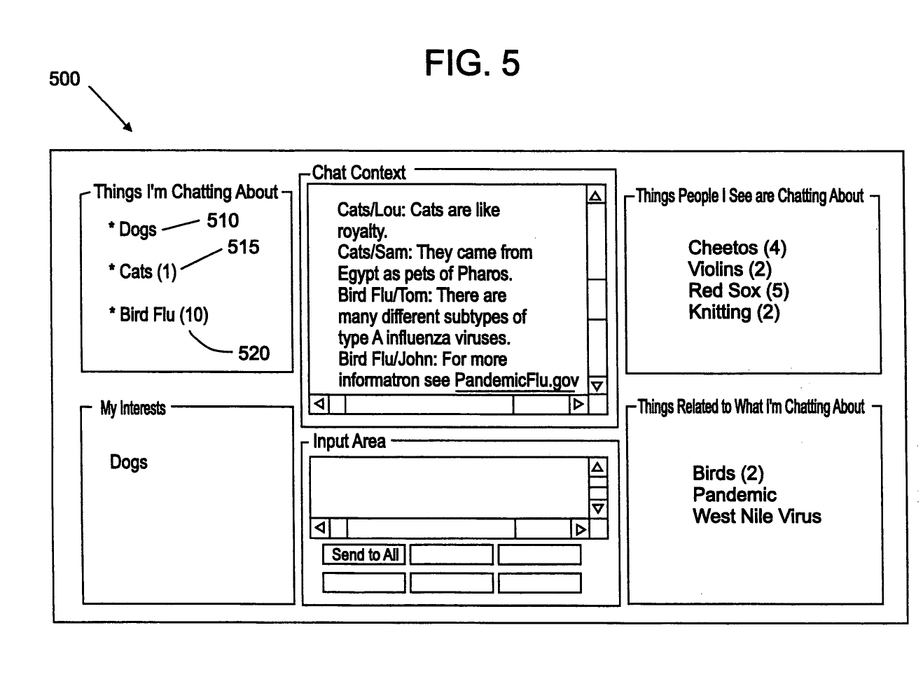

Referring now to FIG. 5, one example of an embodiment of the chat context comprising the single discussion window 500 is depicted. It will be appreciated that the window 500 depicted in FIG. 5 is from the perspective of user Sam, as described above. It will be further appreciated that the chat context window 500 depicted is configured to allow user Sam to discuss the multiple topics of Dogs 505, Cats 510, and Bird Flu 515 within the single discussion window 500, without the need to open a separate discussion window for each discussion topic. While an embodiment of the invention has been depicted as having a chat context with a particular arrangement, it will be appreciated that the scope of the invention is not so limited, and that the invention will also apply to electronic chat systems 100 having any variety of chat contexts that may have any variety of arrangements, wherein multiple topics are discussed within the single discussion window or multiple discussion windows 500.

In view of the foregoing, the electronic chat system 100 performs the method of dynamically generating the topic audience for the primary user to participate therein. The topic audience includes users interested in the same discussion topic of the plurality of topics within the electronic discussion group.

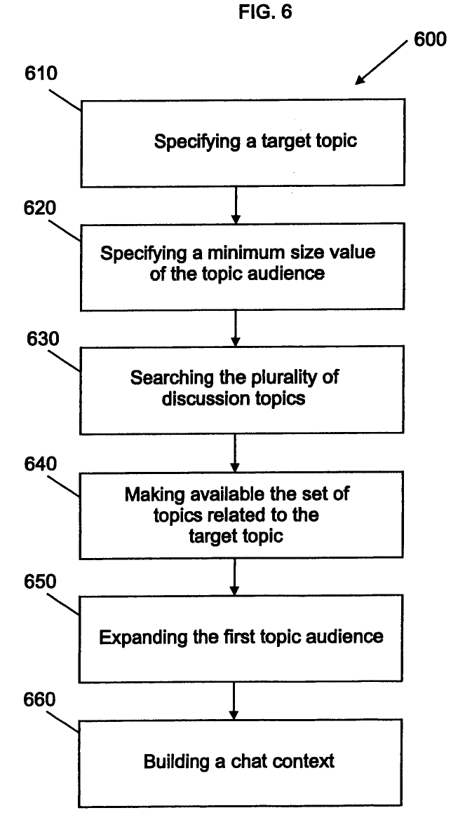

Referring now to FIG. 6, a flow chart 600 of an embodiment of the method is depicted. In an embodiment, the method begins with specifying 610, by the primary user, the target topic of discussion, the target topic of discussion being of interest to the primary user and comprising the first topic audience defined by users interested in the target topic. The method continues with specifying 620, by the primary user, the minimum size value of the first topic audience of the target topic, and, in response to the size value of the first topic audience being less than the specified minimum size value, searching 630 the plurality of discussion topics and identifying the set of topics related to the target topic.

The method further continues with making available 640 to the primary user for selection the set of topics related to the target topic, and, in response to the primary user selecting the topic of the set of topics related to the target topic, expanding 650 the first topic audience to be further defined by the inclusion of the second user interested in the selected topic. In response to the second user in the now-expanded first topic audience also participating in the second topic audience defined by the set of users interested in the additional topic, the method includes making available 640 to the primary user for selection the additional topic. In response to the primary user selecting the additional topic, expanding 650 the first topic audience to be further defined by the inclusion of the set of users interested in the selected additional topic. The method concludes with building 660 a chat context using the expanded first topic audience defined by at least one of the second user and the set of users.

In an embodiment, the building 660 the chat context using the expanded first topic audience defined by inclusion of the second user interested in the related topic and the set of users interested in the additional topic includes the chat context comprising a single discussion window. In an embodiment, the method further comprises displaying to the primary user the number indicative of the quantity of the second users interested in the set of topics related to the target topic and displaying to the primary user the number indicative of the quantity of the set of users interested in the additional topic.

In an embodiment, the method further includes arranging the plurality of discussion topics into a topic organization structure for identifying the set of topics related to the target topic. In an embodiment, the arranging the plurality of discussion topics includes the topic organization structure including one of a directed graph, a hierarchy, a set definition, and keyword-based categorization structure.

In an embodiment, the method further includes specifying, by the primary user, the maximum size value of the first topic audience. In response to the size value of the first topic audience being greater than the specified maximum size value, making available to the primary user for selection the list including the set of topics, and the additional topic used to define the expanded first topic audience. Further, selecting, by the primary user, at least one of the set of topics, and the additional topic, and reducing the first topic audience to be defined exclusive of at least one of the second user interested in the selected set of topics and the set of users interested in the selected additional topic below the specified maximum size value.

In another embodiment, the method further includes specifying a period of time subsequent to a last access, by the second user, of the set of topics related to the target topic. In an embodiment, the searching 630 the plurality of discussion topics and identifying the set of topics related to the target topic comprises the set of topics related to the target topic that have been accessed within a period of time less than the specified period of time.

In another embodiment, the present invention can be included as part of a portable communication device and be used to construct textual, audio, or video socially networked discussions over a telephone system using telephone devices such as cellular telephones.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method to dynamically generate a topic audience for a primary user to participate therein, the topic audience being defined by users interested in a same discussion topic of a plurality of discussion topics within an electronic discussion group, the topic audience having a size value defined by a number of users interested in the same topic, the method comprising:
specifying, by the primary user, a target topic of discussion, the target topic of discussion being of interest to the primary user and comprising a first topic audience defined by users interested in the target topic;
specifying, by the primary user, a minimum size value of the first topic audience;
in response to a size value of the first topic audience being less than the specified minimum size value, searching the plurality of discussion topics and identifying a set of topics related to the target topic;
making available to the primary user for selection the set of topics related to the target topic;
in response to the primary user selecting a topic of the set of topics related to the target topic, expanding the first topic audience to be defined by a second user interested in the selected topic;
in response to the second user also participating in a second topic audience defined by a set of users interested in an additional topic, making available to the primary user for selection the additional topic;
in response to the primary user selecting the additional topic, expanding the first topic audience to be defined by the set of users interested in the selected additional topic; and
building a chat context using the expanded first topic audience defined by at least one of the second user and the set of users.

2. The method of claim 1, wherein:
the building the chat context using the expanded first topic audience defined by at least one of the second user and the set of users comprises the chat context comprising a single discussion window.

3. The method of claim 1, further comprising:
displaying to the primary user a number indicative of a quantity of the second users interested in the set of topics related to the target topic.

4. The method of claim 1, further comprising:
displaying to the primary user a number indicative of a quantity of the set of users interested in the additional topic.

5. The method of claim 1, further comprising:
arranging the plurality of discussion topics into a topic organization structure for identifying the set of topics related to the target topic.

6. The method of claim 5, wherein:
the arranging the plurality of discussion topics comprises the topic organization structure comprising one of a directed graph, a hierarchy, a set definition, and keyword-based categorization structure.

7. The method of claim 1, further comprising:
specifying, by the primary user, a maximum size value of the first topic audience;
in response to the size value of the first topic audience being greater than the specified maximum size value, making available to the primary user for selection a list comprising the set of topics, and the additional topic used to define the expanded first topic audience;
selecting, by the primary user, at least one of the set of topics, and the additional topic; and
reducing the first topic audience to be defined exclusive of at least one of the second user interested in the selected set of topics and the set of users interested in the selected additional topic.

8. The method of claim 1, further comprising:
specifying a period of time subsequent to a last access, by the second user, of the set of topics related to the target topic;
wherein the searching the plurality of discussion topics and identifying the set of topics related to the target topic comprises the set of topics related to the target topic that have been accessed within a period of time less than the specified period of time.

9. A program storage device readable by a computer, the device embodying a program or instructions executable by the computer to perform the method of claim 1.

10. An electronic chat system to dynamically generate a topic audience for a primary user to participate therein, the topic audience being defined by users interested in a same discussion topic of a plurality of discussion topics within an electronic discussion group, the topic audience having a size value defined by a number of users interested in the same topic, the system comprising:
a chat server configured to host a plurality of topic audiences; and
a chat client in signal communication with the chat server, the chat client configured to be responsive to a target topic of discussion specified by the primary user, the target topic of discussion being of interest to the primary user, a first topic audience of the target topic defined by users interested in the target topic;
wherein at least one of the chat client and the chat server are configured to be responsive to a size value of the first topic audience of the target topic being less than a primary user-specified minimum size value of the first topic audience;
wherein at least one of the chat client and the chat server are configured to search the plurality of discussion topics and identify a set of topics related to the target topic in response to the size value of the first topic audience being less than the primary user-specified minimum size value of the first topic audience;
wherein at least one of the chat client and the chat server are configured to make available for selection by the primary user the set of topics;
wherein at least one of the chat client and the chat server are configured to be responsive to the primary user selection of a topic of the set of topics related to the target topic, and to expand the first topic audience to be defined by a second user interested in the selected topic related to the target topic;
wherein at least one of the chat client and the chat server are configured to be responsive to the second user in the expanded first topic audience also participating in a second topic audience defined by a set of users interested in an additional topic, and to make available to the primary user for selection the additional topic;
wherein at least one of the chat client and the chat server are configured to be responsive to primary user selection of the additional topic, and to expand the first topic audience to be defined by the set of users interested in the selected additional topic; and
wherein at least one of the chat client and the chat server are configured to build a chat context using the expanded first topic audience defined by at least one of the second user and the set of users.

11. The system of claim 10, wherein:
at least one of the chat client and the chat server are configured to build the chat context comprising a single discussion window.

12. The system of claim 10, wherein:
at least one of the chat client and the chat server are configured to display to the primary user a number indicative of a quantity of the second users interested in the topic related to the target topic.

13. The system of claim 10, wherein:
at least one of the chat client and the chat server are configured to display to the primary user a number indicative of a quantity of the set of users interested in the additional topic.

14. The system of claim 10, wherein:
at least one of the chat client and the chat server are configured to arrange the plurality of discussion topics into a topic organization structure for identifying the set of topics related to the target topic.

15. The system of claim 14, wherein:
at least one of the chat client and the chat server are configured to arrange the plurality of discussion topics into the topic organization structure comprising one of a directed graph, a hierarchy, a set definition, and a keyword-based categorization structure.

15. The system of claim 10, wherein:
at least one of the chat client and the chat server are is configured to be responsive to specification by the primary user of a maximum size value of the first topic audience;
at least one of the chat client and the chat server are configured to be responsive to the size value of the first topic audience being greater than the maximum size value, and to make available to the primary user for selection a list comprising the set of topics, and the additional topic as used to define the expanded first topic audience; and
at least one of the chat client and the chat server are configured to be responsive to selection by the primary user of at least one of the set of topics, and the additional topic, and to reduce the first topic audience to be defined exclusive of at least one of the second user interested in the selected set of topics and the set of users interested in the selected additional topic.

16. The electronic chat system of claim 10, wherein:
at least one of the chat client and the chat server are configured to be responsive to specification by the primary user of a period of time subsequent to a last access by the second user, of the set of topics related to the target topic; and
at least one of the chat client and the chat server are configured to search the plurality of discussion topics and identify the set of topics related to the target topic that have been accessed within a period of time less than the specified period of time.

17. The electronic chat system of claim 10, wherein:
the electronic discussion is conducted using an audio format.

18. The electronic chat system of claim 10, wherein:
the electronic discussion is conducted using a video format.
